(19) United States
(12) Patent Application Publication
(10) Pub. No.: US 2022/0129127 A1
(43) Pub. Date: Apr. 28, 2022

(54) TRANSMITTING METHOD, RECEIVING METHOD, TRANSMITTING DEVICE, RECEIVING DEVICE, AND TRANSMISSION SYSTEM FOR TOUCH SCREEN INSTRUCTION

(71) Applicant: SHENZHEN LENKENG TECHNOLOGY CO.,LTD, Shenzhen (CN)

(72) Inventor: Binghai GAO, Shenzhen (CN)

(73) Assignee: SHENZHEN LENKENG TECHNOLOGY CO.,LTD, Shenzhen (CN)

(21) Appl. No.: 17/343,753

(22) Filed: Jun. 10, 2021

(30) Foreign Application Priority Data
Oct. 27, 2020 (CN) 202011166265.0

(51) Int. Cl. G06F 3/041; G09G 3/20

(52) U.S. Cl. CPC G06F 3/04162; G09G 3/2096; G09G 2370/08; G09G 2370/06; G09G 2354/00

(57) ABSTRACT

Disclosed are a transmitting method, a receiving method, a receiving device, a transmitting device, a receiving device, and a transmission system for touch screen instruction, where the transmitting method includes the following. A receiving device obtains touch screen instruction from a touch screen via an interface of a first transmission medium, and the touch screen instruction comprises a user operation input to the touch screen. The receiving device superimposes a common mode signal obtained by processing the touch screen instruction with a differential mode signal obtained through processing the differential signal to obtain a mixed signal comprising the touch screen instruction. The receiving device transmits the mixed signal to a transmitting device via a network port. By adopting this disclosure, the touch screen instruction is transmitted via a cable, which can realize the control of the video source device connected to the transmitting device. The user experience is high.

### CROSS REFERENCE TO RELATED APPLICATION

The present application claims priority to Chinese Patent Application Serial No. 202011166265.0 on Oct. 27, 2020, the disclosure of which is herein by incorporated by reference.

### TECHNICAL FIELD

The disclosure relates to the technical field of network communication, and particularly to a transmitting method, a receiving method, a transmitting device, a receiving device, and a transmission system for a touch screen instruction.

### BACKGROUND

High definition multimedia interface (HDMI) transmission refers to the long-distance transmission of HDMI source signal to a display. HDMI is currently very widely used. With the development of technology, audio and video technology has also rapidly developed. Most high-definition (HD) players, DVDs, set-top boxes, projectors, LCD TVs and personal computers (PC) have HDMI.

In the related technology, during the HDMI transmission, the effective transmission distance between the control instruction or control signal outputted from the control device and the video source device is generally about 20 meters. Beyond this distance, the strength of the control instruction or control signal will gradually decrease. As the distance increases, the control signal is seriously distorted.

### SUMMARY

Based on the above problems and the shortcomings of the prior art, the disclosure provides a transmitting method, a receiving method, a transmitting device, a receiving device, and a transmission system for a touch screen instruction, which can realize the control of video source device through cable transmission of a touch screen instruction. The user experience is high.

In a first aspect, a transmitting method, a receiving method, a transmitting device, a receiving device, and a transmission system for a touch screen instruction are provided, where the transmitting method comprises the following.

A touch screen instruction is obtained, by a receiving device, from a touch screen via an interface of a first transmission medium, where the touch screen instruction comprise a user operation input to the touch screen.

The receiving device superimposes a common mode signal obtained through processing the touch screen instruction with a differential mode signal obtained through processing the differential signal to obtain a mixed signal including the touch screen instruction.

The receiving device transmits the mixed signal via a network port.

In a second aspect, a receiving method for touch screen instruction is provided. The receiving method comprises the following.

A mixed signal including a touch screen instruction is received by the transmitting device via the network port.

The transmitting device processes the mixed signal to obtain the touch screen instruction, where the touch screen instruction is used to control a video source device connected to the transmitting device.

In a third aspect, a receiving device is provided. The device comprises:

a memory and a processor coupled to the memory, where the memory is configured to store application program code, and the processor is configured to invoke the application program code to perform the transmitting method for the touch screen instruction described in the first aspect.

In a fourth aspect, a transmitting device is provided. The device comprises:

a memory and a processor coupled to the memory; where the memory is configured to store application program code, and the processor is configured to invoke the application program code to perform the receiving method for the touch screen instruction described in the second aspect.

A transmitting method, a receiving method, a transmitting device, a receiving device, and a transmission system for touch screen instruction are provided, where the transmitting method comprises the following. A receiving device obtains the touch screen instruction from the touch screen via an interface of a first transmission medium. The receiving device superimposes a common mode signal obtained through processing the touch screen instruction with a differential mode signal obtained through processing the differential signal to obtain a mixed signal including the touch screen instruction. The receiving device transmits the mixed signal to the transmitting device via the network port. By adopting this disclosure, the touch screen instruction is transmitted via the network cable for achieving controlling of the video source device connected to the transmitting device. The user experience is high.

### BRIEF DESCRIPTION OF THE DRAWINGS

In order to explain the technical solutions in implementations of the disclosure more clearly, the drawings used in the description of the implementations are briefly introduced below. Obviously, the drawings in the following description are some implementations of the disclosure. For ordinary technicians, other drawings can be obtained based on these drawings without paying creative work.

FIG. 1 is a schematic diagram of a transmitting method for a touch screen instruction according to the disclosure.

FIG. 2 is a schematic structural diagram of part of the circuit of a receiving device according to the disclosure.

FIG. 3 is a schematic diagram of a differential mode signal according to the disclosure.

FIG. 4 is a schematic diagram of a common mode signal according to the disclosure.

FIG. 5 is a schematic diagram of a mixed signal according to the disclosure.

FIG. 6 is a schematic diagram of a receiving method of a touch screen instruction according to the disclosure.

FIG. 7 is a schematic structural diagram of the receiving device according to the disclosure.

FIG. 8 is a schematic structural diagram of a transmitting device according to the disclosure.

FIG. 9 is a transmission system for a touch screen instruction according to the disclosure.

### DETAILED DESCRIPTION

The technical solutions in the disclosure will be described clearly and completely in combination with the drawings in the disclosure. Obviously, the described implementations are part of the implementations of the disclosure, but are not all of the implementations. Based on the embodiments in this disclosure, all other embodiments obtained without creative work by those of ordinary skill in the art shall fall within the scope of protection of this disclosure.

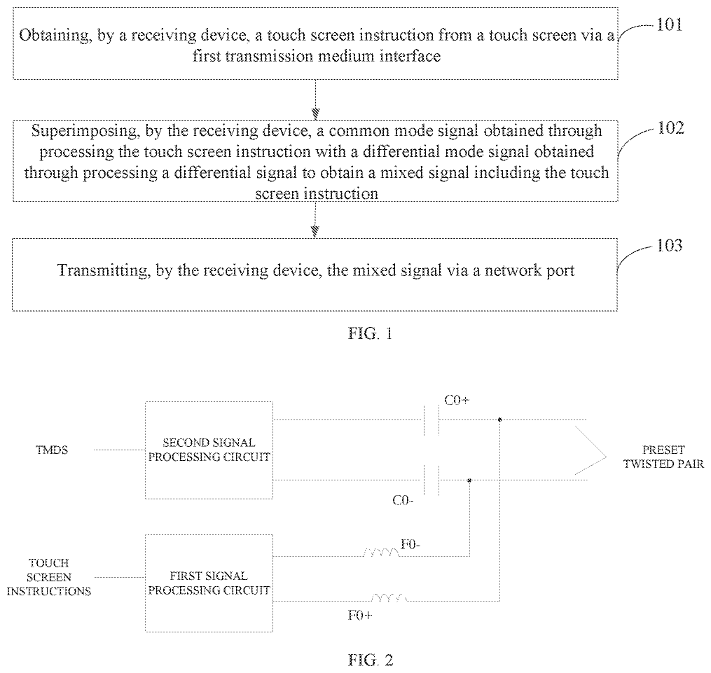

In order to better illustrate how a touch screen instruction is transmitted, this disclosure will be specified in conjunction with FIG. 1.

FIG. 1 is a schematic flow diagram of the transmitting method for a touch screen instruction according to the disclosure. As shown in FIG. 1, the transmitting method may comprise at least the following.

At block 101, the touch screen instruction is obtained, by a receiving device, from the touch screen via an interface of a first transmission medium.

According to an embodiment of the disclosure, the touch screen instruction is obtained by the receiving device from the touch screen via the interface the first transmission medium, which may comprise, but is not limited to, the following.

Method 1

The receiving device obtains the touch screen instruction from the touch screen via a USB interface integrated into the receiving device. Where the USB interface may comprise, but is not limited to, a USB 1.1 interface, a USB 1.0 interface, a USB 2.0 interface, a USB 3.0 interface, or a Type-C interface.

Method 2

The receiving device obtains the touch screen instruction from the touch screen via a RS232 interface integrated into the receiving device.

Method 3

The receiving device obtains the touch screen instruction from the touch screen via a serial peripheral interface (SPI) integrated into the receiving device.

Method 4

The receiving device obtains the touch screen instruction from the touch screen via an I2C interface integrated into the receiving device.

The touch screen instruction comprises a user operation inputted by the user onto the touch screen.

The user operation inputted by the user onto the touch screen may comprise:

clicking on the touch screen by a user, double clicking on the touch screen by a user, sliding the touch screen by a user, or spacing the touch screen by a user.

It should be noted that the touch screen instruction may also comprise, but is not limited to, a user-inputted location information inputted onto the touch screen, such as location information for clicking on the touch screen by a user, location information for double clicking on the touch screen by a user, location information for sliding on the area of the touch screen by a user, or location information for spacing operating, by a user, the area of the touch screen mapped onto the touch screen.

It should be noted that in addition to obtaining a touch screen instruction from the touch screen via the interface of the first transmission medium, the receiving device may also comprise the following.

The receiving device receives an infrared signal via a first infrared receiving tube, and then converts the infrared signal into an electrical signal, samples the electrical signal by a sampling module to obtain a fully sampling signal, and demodulates the fully sampling signal to obtain a binary coded signal and a pulse signal. A demodulation control data can be obtained according to the binary coded signal, and a carrier frequency data can be obtained according to the pulse signal. A first signal can be generated according to the binary coded signal and the carrier frequency data, and the receiving device can output the first signal to the transmitting device via the network port.

At block 102, the receiving device superimposes a common mode signal obtained by processing the touch screen instruction with a differential mode signal obtained by processing the differential signal to obtain a mixed signal including the touch screen instruction.

According to an embodiment of the disclosure, the transmitting method further includes the following. Before the receiving device superimposes the common mode signal obtained through processing the touch screen instruction with the differential mode signal obtained through processing the differential signal, the receiving device obtain a differential signal, where the differential signal may comprise, but is not limited to, a transition-minimized differential signaling (TMDS) signal.

The receiving device superimposes the common mode signal obtained through processing the touch screen instruction with the differential mode signal obtained through processing the differential signal to obtain a mixed signal including the touch screen instruction, which comprises the following.

The receiving device converts the touch screen instruction into a serial data by the conversion chip of the first signal processing circuit, processes the serial data into a common mode signal by a first signal processing circuit, and superimposes the common mode signal with the differential mode signal obtained through processing the differential signal by a second signal processing circuit on a preset twisted pair to obtain a mixed signal including the touch screen instruction. Where the above preset twisted pair includes a pair of twisted pair wires formed by two wires twisted around each other, and the serial data may comprise, but is not limited to, a RS232 signal or universal asynchronous receiver/transmitter (UART) signal.

FIG. 2 is a schematic structural diagram of part of the circuit of the receiving device. As shown in FIG. 2, the receiving device superimposing a common mode signal obtained through processing the touch screen instruction by the first signal processing circuit with a differential mode signal obtained through processing the TMDS signal by the second signal processing circuit on a preset twisted pair to obtain a mixed signal. Where C0+ and C0− are capacitors, and F0+ and F0− are inductors, respectively. It should be noted that the C0+ and the C0− are used to enable the passage of an alternating current signal (AC) signal such as a differential-mode signal, but have an isolating effect on a direct current (DC) signal such as a common-mode signal, and the F0+ and the F0− are used to enable the passage of the DC signal such as the common-mode signal, but have an isolating effect on the AC signal such as differential-mode signal.

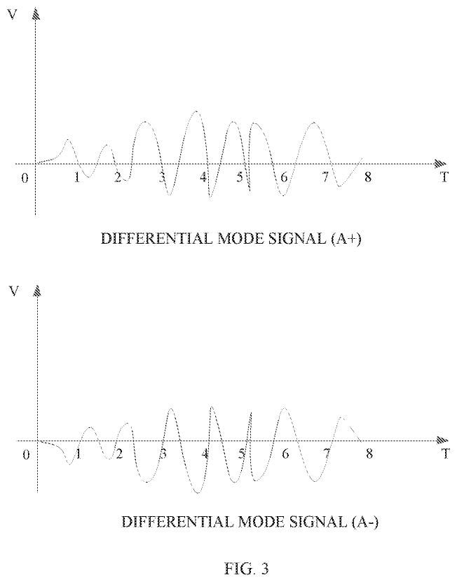

The process of superimposing the common mode signal with the differential mode signal to obtain the mixed signal is described below in conjunction with FIGS. 3-5.

FIG. 3 is a schematic diagram of a differential mode signal. As shown in FIG. 3, the differential mode signal may comprise a differential mode signal (A+) and a differential mode signal (A−), where the voltage (V) of the differential mode signal varies with time T, X is a constant, and it should be noted that the vertical axis represents the voltage (V) and the horizontal axis represents the time (T).

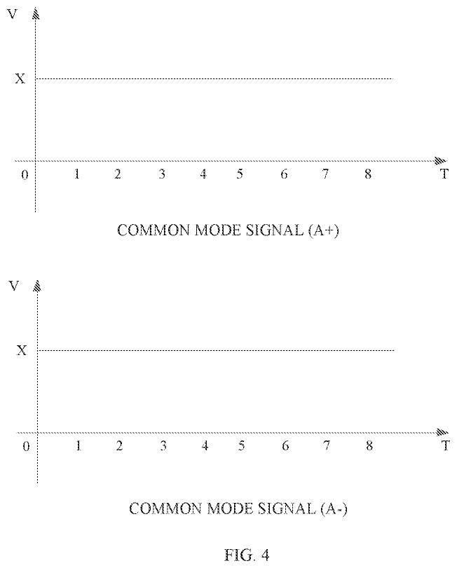

FIG. 4 is a schematic diagram of a common mode signal. As shown in FIG. 4, the common mode signal may comprise a common mode signal (A+) and a common mode signal (A−), where the voltage (V) of the common mode signal varies with time T, X is a constant, and it should be noted that the vertical axis represents the voltage (V) and the horizontal axis represents the time (T).

FIG. 5 is a schematic diagram of a mixed signal. As shown in FIG. 5, the mixed signal is obtained through superimposing the differential mode signal shown in FIG. 3 with the common mode signal shown in FIG. 4. Where X is a constant, and the vertical axis represents voltage (V) and the horizontal axis represents time (T).

At block 103, the receiving device transmits the mixed signal via the network port.

According to an embodiment of the disclosure, the receiving device transmits the mixed signal via the network port, which includes the following.

The receiving device transmits the mixed signal including the touch screen instruction to the transmitting device based on the preset twisted pair integrated inside the receiving device via a network port and a cable coupled to the network port (e.g., cat5, cat5e, cat6, Cat6a or Cat7), where the network port of the receiving device is a cable interface for use between the network card and the network.

Specifically, the receiving device transmits the mixed signal including the touch screen instruction to the transmitting device based on the preset twisted pair and a network port integrated respectively inside the receiving device and a cable coupled to the network port. Optionally, the length of the cable may be 70 m, and the embodiment of the disclosure is not limited.

More specifically, the receiving device transmits the common mode signal based on the common mode channel via the network port and the cable coupled to the network port, and transmits the differential mode signal to the transmitting device based on the differential mode channel via the network port and the cable coupled to the network port.

It should be noted that FIGS. 2-5 should not limit the present disclosure due to the description of the embodiments of the disclosure only.

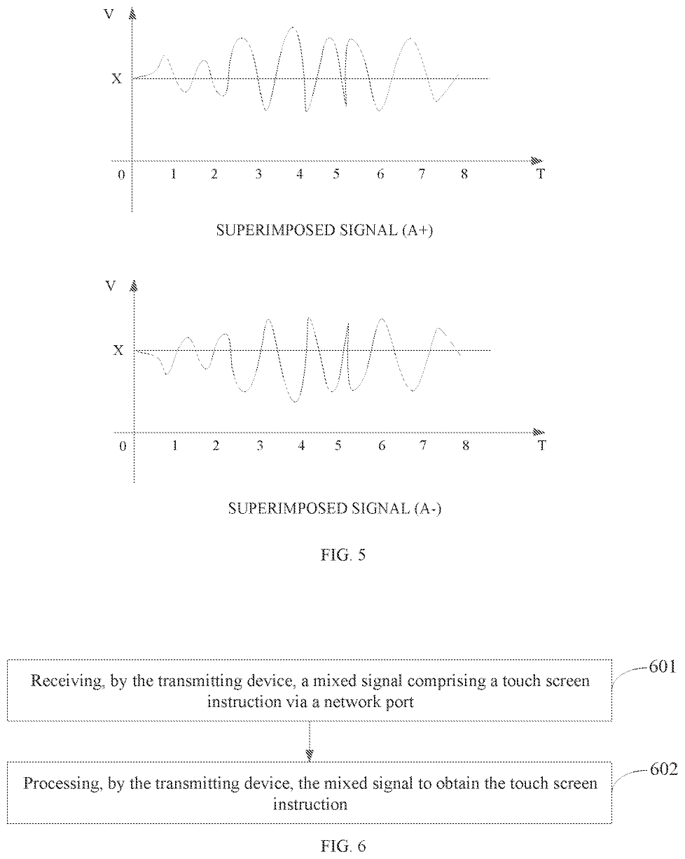

In order to better illustrate how the touch screen instruction is received, the disclosure will be described in conjunction with FIG. 6.

FIG. 6 is a schematic flow diagram of the receiving method for a touch screen instruction according to the disclosure. As shown in FIG. 6, the method may comprise at least the following.

At block 601, the transmitting device receives the mixed signal including the touch screen instruction via the network port.

According to an embodiment of the disclosure, the transmitting device receives the mixed signal including the touch screen instruction via the network port, which may include, but is not limited to, the following.

The transmitting device receives the mixed signal transmitted by the receiving device via the network port, the cable coupled to the network port (e.g., cat5, cat5e, cat6, Cat6a or Cat7) and the preset twisted pair integrated inside the receiving device. Where the network port of the transmitting device is a cable interface. Optionally, the length of the twisted pair may be 70 m.

At block 602, the transmitting device processes the mixed signal to obtain the touch screen instruction.

According to an embodiment of the disclosure, the transmitting device processes the mixed signal to obtain the touch screen instruction, which comprises the following.

The transmitting device extracts or filters the mixed signal by a first inductor circuit to obtain a common mode signal, processes the common mode signal by a third signal processing circuit to obtain serial data, and converts the serial data into the touch screen instruction by a conversion chip of the third signal processing circuit, where the first inductor circuit is a circuit including an inductor and configured to extract or filter the common mode signal from the mixed signal and other DC signal, and the third signal processing circuit is configured to process the common mode signal to obtain the touch screen instruction. Where the serial data may include, but is not limited to, RS232 signal or UART signal.

More specifically, the transmitting device may extract or filter the mixed signal via the first inductor circuit to obtain the common mode signal, and perform the averaging operation on the common mode signal to obtain a touch screen instruction. For example, the differential mode signal obtained is averaged to obtain the touch screen instruction.

It should be noted that the transmitting device may extract the mixed signal by a circuit that includes electricity to obtain a differential mode signal.

It should be noted that the touch screen instruction is configured to control the video source device connected to the receiving device.

After the transmitting device processes the mixed signal to obtain the touch screen instruction, the receiving method may further include, but is not limited to, the following.

The transmitting device transmits the touch screen instruction to the video source device via the interface of the second transmission medium to control audio and video data outputted from the video source device to the transmitting device via the high definition multimedia interface (HDMI), video graphics array (VGA) interface, Type-C interface, display port (DP) interface, or digital visual interface (DVI) of the transmitting device.

It should be noted that the transmitting device transmits the touch screen instruction to the video source device via the interface of the second transmission medium, which may include, but is not limited to, the following.

Method 1

The transmitting device transmits the touch screen instruction to the video source device via the USB interface of the transmitting device. Where the USB interface may include, but is not limited to, a USB1.1 interface, USB1.0 interface, USB2.0 interface, or USB3.0 interface.

Method 2

The transmitting device transmits the touch screen instruction to the video source device via a RS232 interface of the transmitting device.

Method 3

The transmitting device transmits the touch screen instruction to the video source device through an I2C interface of the transmitting device.

Method 4

The transmitting device transmits the touch screen instruction to the video source device through a serial peripheral interface (SPI) of the transmitting device.

It should be noted that the transmitting device receives the first signal via the internally integrated network port in addition to the touch screen instruction, and parses the first signal to obtain carrier frequency data and a binary encoded signal. The transmitting device loads the binary encoded signal onto the carrier generated according to the carrier frequency data to obtain a loaded signal, and processes the loaded signal into an infrared signal. The transmitting device transmits the infrared signal to the video source device connected to the transmitting device by the infrared emitting tube integrated in the transmitting device to achieve the control of the video source device (e.g., switching of playback content, adjusting the volume).

In summary, by adopting the disclosure, the transmitting device receives the mixed signal including the touch screen instruction via an internally integrated network port, extracts the mixed signal by a circuit including an inductor to obtain a common mode signal, and operates the common mode signal by a third signal processing circuit to obtain the touch screen instruction, where the touch screen instruction is configured to control a video source device connected to the transmitting device.

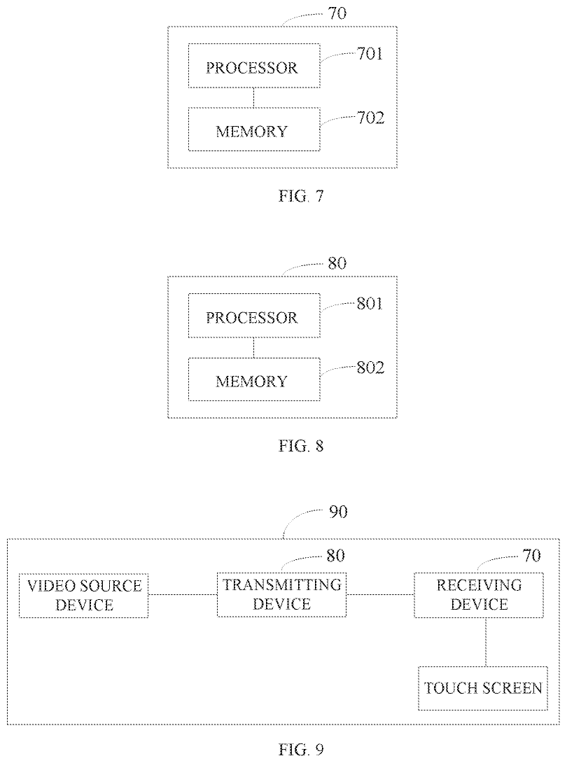

The disclosure provides a receiving device for transmitting a touch screen instruction, and the receiving device for transmitting the touch screen instruction shown in FIG. 7 can be configured to perform the method described in the embodiment of FIG. 1.

As shown in FIG. 7, the receiving device 70 may include, but is not limited to, a processor 701 and a memory 702 coupled to the processor 701.

The memory 702 can be configured to store an application program instruction.

The processor 701 may be configured to invoke the application program instruction from the memory 702 to implement the transmitting method for the touch screen instruction as described in the embodiment of FIG. 1.

It should be noted that the receiving device 70 comprises a processor 701 and a memory 702 in addition, the receiving device 70 further comprises an input interface and an output interface. Where,

the input interface may be configured to obtain the touch screen instruction from the touch screen, and the input interface may include, but is not limited to, a universal serial bus (USB) interface, a RS232 interface, a serial peripheral interface (SPI), or an I2C interface.

The processor 701 configured to superimpose the common mode signal obtained by processing the touch screen instruction with the differential mode signal obtained through processing the differential signal to obtain the mixed signal including the touch screen instruction is configured to:

superimpose the common mode signal obtained through processing the touch screen instruction with the differential mode signal obtained through processing the differential signal on a preset twisted pair to obtain a mixed signal including the touch screen instruction. Where the preset twisted pair is a pair of twisted pair, and the differential signal may include, but is not limited to, a transition-minimized differential signaling (TMDS) signal.

The processor 701 is further configured to transmit the mixed signal via the output interface and the preset twisted pair integrated inside the receiving device 70, where the output interface may include, but is not limited to, a network port.

The processor 701 configured to superimpose the common mode signal obtained through processing the touch screen instruction with the differential mode signal obtained through processing the differential signal to obtain the mixed signal including the touch screen instruction is further configured to:

superimpose the common mode signal obtained through processing the touch screen instruction by the first signal processing circuit with the differential mode signal obtained through processing the differential signal by the second signal processing circuit on the preset twisted pair to obtain the mixed signal including the touch screen instruction.

The processor 701 can further be specifically configured to obtain the differential signal, before the processor is configured to superimpose the common mode signal obtained through processing the touch screen instruction with the differential mode signal obtained through processing the differential signal.

It should be understood that the receiving device 70 is only one example provided by the disclosure, and the receiving device 70 may have more or fewer components than shown, may combine two or more component, or may have different configurations of components implemented.

It will be understood that specific implementations of the functional components included in the receiving device 70 of FIG. 7 may be referred to the embodiment of the FIG. 1 and will not be repeated here.

The present disclosure provides a transmitting device for receiving the touch screen instruction, and the transmitting device for receiving the touch screen instruction shown in FIG. 8 may be used to perform the method described in the embodiment of FIG. 6.

As shown in FIG. 8, the transmitting device 80 may include, but is not limited to, a processor 801 and a memory 802 coupled to the processor 801.

The memory 802 can be configured to store application program instruction.

The processor 801 can be configured to invoke application instruction from the memory 802, and implement the receiving method for the touch screen instruction described in the embodiment of FIG. 6.

In addition to the processor 801 and the memory 802, the transmitting device 80 may further comprise an input interface and an output interface.

The input interface can be configured to receive the mixed signal including the touch screen instruction, where the input interface may include, but is not limited to, a network port.

The processor 801 can be configured to:

Process, via the preset twisted pair integrated in the transmitting device 80, the input interface integrated in the transmitting device 80 and the cable coupled to the input interface, the mixed signal obtained to obtain the touch screen instruction, where the touch screen instruction is used to control the video source device connected to the receiving device.

The processor 801 configured to process the mixed signal obtained to obtain the touch screen instruction is configured to:

extract the mixed signal obtained to obtain a common mode signal and process the common mode signal to obtain the touch screen instruction.

It should be noted that the output interface may be configured to output the touch screen instruction to the video source device for controlling the video source device to output audio and video data to the transmitting device via the HDMI, Type-C interface, DP interface, VGA interface or DVI of the transmitting device 80, after the mixed signal is processed, by the processor 801, to obtain the touch screen instruction.

It should be noted that the output interface may include, but is not limited to, a USB interface, a RS232 interface, a SPI, or an I2C interface.

It should be understood that transmitting device 80 is only one example provided by the disclosure, and the transmitting device 80 may have more or fewer components than shown, may combine two or more components, or may have different configurations of components implemented.

It will be understood that specific implementation of the functional components included in the transmitting device 80 of FIG. 8 may be referred to the embodiment of FIG. 6 and will not be repeated herein.

The disclosure provides a transmitting transmission system for touch screen instruction. As shown in FIG. 9, the transmission system 90 may include, but is not limited to, a receiving device as described in FIG. 7 and a transmitting device as described in FIG. 8. Where, the receiving device 70 is connected to the transmitting device 80 via a cable.

It should be noted that the receiving device 70 may obtain the touch screen instructions from the touch screen via the interface of the first transmission medium, which may include, but is not limited to a USB interface, a RS232 interface, a serial peripheral interface (SPI), or an I2C interface.

The receiving device 70 may superimpose a common mode signal obtained through processing the touch screen instruction with the differential mode signal obtained through processing the differential signal via the input interface of the receiving device 70 to obtain a mixed signal including the touch screen instruction, and transmit the mixed signal via the output interface of the receiving device 70. Where the output interface of the receiving device 70 may include, but is not limited to, a network port.

It should be noted that the transmitting device 80 may receive a mixed signal including the touch screen instruction via the input interface of the transmitting device 80, process the mixed signal received via the input interface of the transmitting device 80 to obtain a touch screen instruction, and transmit the touch screen instruction to the video source device to control the video source device outputting audio and video data to the transmitting device through a high definition multimedia interface (HDMI), Type-C interface, display port (DP) interface, a video graphics array (VGA) interface or digital display working group (DVI) of the transmitting device. Where the touch screen instruction is used to control the video source device connected to the transmitting device, the input interface may include, but is not limited to, a network port.

It should be noted that the specific embodiment of the receiving device 70 included in the transmission system of FIG. 9 may be referred to the embodiment of the receiving device of FIG. 7, and the specific embodiment of the transmitting device 80 may be referred to the embodiment of the transmitting device of FIG. 8. Those ordinary skilled in the art may realize that the modules and algorithm steps of each example described in combination with the implementations of the disclosure can be performed by electronic hardware, computer software, or a combination thereof. In order to clearly explain the interchangeability of hardware and software, the composition and steps of each example have been described generally in terms of functions in the above description. Whether these functions are performed in hardware or software depends on the specific application and design constraints of the technical solution. Professional technicians can use different methods to implement the described functions for each specific application, but such implementation should not be considered to be beyond the scope of the disclosure.

Those skilled in the art can clearly understand that, for the convenience and brevity of the description, the specific working processes of the devices and modules described above can refer to the corresponding processes in the foregoing implementations of method, and are not repeated here.

In the several implementations provided in the disclosure, it should be understood that the disclosed equipment, device, and method may be implemented in other ways. For example, to describe the composition and steps of each example. Whether these functions are executed in hardware or software depends on the specific application of the technical solution and design constraints. Professional technicians can use different methods to implement the described functions for each specific application, but such implementation should not be considered beyond the scope of this disclosure.

The implementations of device and equipment described above are only schematic. For example, the division of the modules is only a logical function division. In actual implementation, there may be another division manner. For example, multiple modules or components may be combined or integrated into another device, or some features can be ignored or not be implemented.

In addition, the displayed or discussed mutual coupling or direct coupling or communication connection may be indirect coupling or communication connection via some interfaces, equipment, devices or modules, and may also be electrical, mechanical or other forms of connection.

The modules described as separate components may or may not be physically separated, and the components displayed as modules may or may not be physical modules, may be located in one place, or may be distributed on multiple network modules. Some or all of the modules may be selected according to actual needs to achieve the objects of the solutions in the implementations of the disclosure.

In addition, each functional module in each implementation of the disclosure may be integrated into one processing module, or each module may exist separately physically, or two or more modules may be integrated into one module. The above integrated modules may be implemented in the form of hardware or software functional modules.

When the integrated module is implemented in the form of a software functional module and sold or used as an independent product, it can be stored in a computer-readable storage medium.

Based on this understanding, the technical solution of the disclosure essentially or a part that contributes to the existing technology, or all or part of the technical solution may be embodied in the form of a software product. The computer software product is stored in a storage medium which includes instructions to enable a computer device (which may be a personal computer, a server, or a network device, etc.) to perform all or part of the steps of the method described in the implementations of the disclosure. The foregoing storage media include: U-disks, mobile hard disks, read-only memory (ROM), random access memory (RAM), magnetic disks, or optical disks and other media that can store program codes.

The above is only a specific implementation of the disclosure, but the scope of protection of the disclosure is not limited to this. Any person skilled in the art can easily think of various equivalent modifications or replacements within the technical scope disclosed in the disclosure which should be covered by the protection scope of the disclosure. Therefore, the protection scope of the disclosure shall be subject to the protection scope of the claims.

What is claimed is:

1. A transmitting method for touch screen instruction, comprising:
obtaining, by a receiving device, a touch screen instruction from a touch screen via a first transmission medium interface; the touch screen instruction comprising a user operation input to the touch screen;
superimposing, by the receiving device, a common mode signal obtained through processing the touch screen instruction with a differential mode signal obtained through processing a differential signal to obtain a mixed signal including the touch screen instruction; and
transmitting, by the receiving device, the mixed signal via a network port.

2. The transmitting method according to claim 1, wherein
obtaining, by the receiving device, the touch screen instruction from the touch screen via the first transmission medium interface comprises:
obtaining, by the receiving device, the touch screen instruction from the touch screen via a universal serial bus (USB) interface of the receiving device;
obtaining, by the receiving device, the touch screen instruction from the touch screen via a RS232 interface of the receiving device;
obtaining, by the receiving device, the touch screen instruction from the touch screen via a serial peripheral interface (SPI) of the receiving device; or
obtaining, by the receiving device, the touch screen instruction from the touch screen via an I2C interface of the receiving device.

3. The transmitting method according to claim 1, wherein
superimposing, by the receiving device, the common mode signal obtained through processing the touch screen instruction with the differential mode signal obtained through processing the differential signal to obtain the mixed signal including the touch screen instruction comprises:
superimposing, by the receiving device, the common mode signal obtained through processing the touch screen instruction by a first signal processing circuit with the differential mode signal obtained through processing the differential signal by a second signal processing circuit on a preset twisted pair to obtain the mixed signal including the touch screen instruction; and the preset twisted pair is a pair of twisted pair.

4. The transmitting method according to claim 3, wherein
transmitting, by the receiving device, the mixed signal via the network port comprises:
transmitting, by the receiving device, the mixed signal on the basis of the preset twisted pair via the network port.

5. The transmitting method according to claim 4, wherein
the preset twisted pair comprises a common mode channel and a differential mode channel; and
transmitting, by the receiving device, the mixed signal on the basis of the preset twisted pair via the network port comprises:
transmitting, by the receiving device, the common mode signal on the basis of a common mode channel via the network port, and
transmitting the differential mode signal on the basis of a differential mode channel via the network port.

6. The transmitting method according to claim 3, wherein
processing, by the receiving device, the touch screen instruction by the first signal processing circuit to obtain the common mode signal comprises:
converting, by the receiving device, the touch screen instruction into serial data by a conversion chip of the first signal processing circuit, and processing the serial data into the common mode signal by the first signal processing circuit.

7. The transmitting method according to claim 1, wherein the transmitting method further comprises:
before superimposing, by the receiving device, the common mode signal obtained through processing the touch screen instruction with the differential mode signal obtained through processing the differential signal, the receiving device obtains a differential signal.

8. A receiving method for a touch screen instruction, comprising:
receiving, by the transmitting device, a mixed signal comprising a touch screen instruction via a network port;
processing, by the transmitting device, the mixed signal to obtain the touch screen instruction;
wherein the touch screen instruction is used to control a video source device connected to the transmitting device.

9. The receiving method according to claim 8, wherein the receiving method further comprises:
after processing, by the transmitting device, the mixed signal to obtain the touch screen instruction,
the transmitting device transmits the touch screen instruction to the video source device via an interface of a second transmission medium to control the video source device outputting audio and video data to the transmitting device via a high definition multimedia interface (HDMI), a Type-C interface, a display port (DP) interface, a video graphics array (VGA) interface or a digital visual interface (DVI) of the transmitting device.

10. The receiving method according to claim 9, wherein
transmitting, by the transmitting device, the touch screen instruction to the video source device via the interface of the second transmission medium comprises:
transmitting, by the transmitting device, the touch screen instruction to the video source device via a universal serial bus (USB) interface of the transmitting device,
transmitting, by the transmitting device, the touch screen instruction to the video source device via a RS232 interface of the transmitting device;
transmitting, by the transmitting device, the touch screen instruction to the video source device via an I2C interface of the transmitting device; or
transmitting, by the transmitting device, the touch screen instruction to the video source device via a serial peripheral interface (SPI) of the transmitting device.

11. The receiving method according to claim 8, wherein
processing, by the transmitting device, the mixed signal to obtain the touch screen instruction, comprises:
extracting, by the transmitting device, the mixed signal to obtain a common mode signal; and
processing the common mode signal to obtain the touch screen instruction.

12. The receiving method according to claim 11, wherein
processing the common mode signal to obtain the touch screen instruction comprises:
processing the common mode signal to obtain serial data and converting the serial data into the touch screen instruction by a conversion chip.

13. A transmitting device, comprising:
a memory configured to store application program code; and
a processor coupled to the memory and configured to invoke the application program code to:
obtain a touch screen instruction from the touch screen via the interface of the first transmission medium; wherein the touch screen instruction comprises a user operation input to the touch screen;
superimpose the common mode signal obtained by processing the touch screen instruction with the differential mode signal obtained through processing the differential signal to obtain the mixed signal including the touch screen instruction; wherein the mixed signal is transmitted via the network port.

14. The transmitting device according to claim 13, wherein
the first transmission medium interface comprises a universal serial bus (USB) interface, a RS232 interface, a serial peripheral interface (SPI) or an I2C interface.

15. The transmitting device according to claim 13, wherein
the processor configured to superimpose the common mode signal obtained by processing the touch screen instruction with the differential mode signal obtained through processing the differential signal to obtain the mixed signal including the touch screen instruction is configured to:
superimpose the common mode signal obtained through processing the touch screen instruction with the differential mode signal obtained through processing the differential signal on a preset twisted pair to obtain a mixed signal comprising the touch screen instruction; wherein the preset twisted pair is a pair of twisted pair.

16. The transmitting device according to claim 15, wherein
the processor configured to obtain the common mode signal through processing the touch screen instruction is configured to:
convert the touch screen instruction into serial data, and process the serial data to obtain the common mode signal.

17. A receiving device, comprising:
a memory configured to store application program code; and
a processor coupled to the memory and configured to invoke the application program code to:
receive a mixed signal comprising a touch screen instruction via the network port;
process the mixed signal to obtain the touch screen instruction; wherein the touch screen instruction is used to control the video source device connected to a transmitting device.

18. The receiving device according to claim 17, wherein
the receiving device further comprises a second transmission medium interface;
the second transmission medium interface is configured to transmit the touch screen instruction to the video source device to control audio and video data outputted from the video source device to the transmitting device via a high definition multimedia interface (HDMI), a Type-C interface, a display port (DP) interface, a video graphics array (VGA) interface or a digital display working group (DVI) of the transmitting device; and
the interface of the second transmission medium comprises a universal serial bus (USB) interface, a RS232 interface, an I2C interface or a serial peripheral interface (SPI).

19. The receiving device according to claim 17, wherein
the processor configured to process the mixed signal to obtain the touch screen instruction is configured to:
extract the mixed signal to obtain a common mode signal and process the common mode signal to obtain the touch screen instruction.

20. The receiving device according to claim 19, wherein
the processor configured to process the common mode signal to obtain the touch screen instruction is configured to:
process the common mode signal to obtain serial data and convert the serial data into the touch screen instruction by the conversion chip.
